(19) United States
(12) Patent Application Publication
(10) Pub. No.: US 2006/0193336 A1
(43) Pub. Date: Aug. 31, 2006

(54) Local area network above cable television methods and devices

(75) Inventors: James F. Landry, Germantown, MD (US); Andrew Pozsgay, Germantown, MD (US)

Correspondence Address: VOLENTINE FRANCOS & WHITT, PLLC, SUITE 1260, 11951 FREEDOM DRIVE, RESTON, VA, 20190, US

(73) Assignee: TELKONET, INC.

(21) Appl. No.: 11/064,962

(22) Filed: Feb. 25, 2005

(51) Int. Cl. H04H 1/04; H04J 1/00; H04L 12/28; H04J 11/00

(52) U.S. Cl. 370/431; 370/208

(57) ABSTRACT

A method and apparatus for modifying a cable network to create a local area network is disclosed. By employing a communications modem configured to transmit first communication signals over one or more coaxial cables using a first allocated spectrum designed to avoid contention with ongoing upstream television control signals, an infrastructure capable of carrying demand cable television and LAN signals can be created.

### FIELD OF THE INVENTION

The methods and systems of this disclosure relate to adapting cable television infrastructures to carry both video services and broadband network communication signals.

### BACKGROUND OF THE INVENTION

The ability to interconnect computers and other intelligent devices is a common requirement wherever people live and work today. The electrical connections required to form many local area network (LAN) communication systems have traditionally been accomplished by installing dedicated wiring both inside buildings and between clusters of buildings. A number of wireless (i.e. radio) methods have also been developed and deployed to address this need.

More recently, a power-wire based technology was developed to allow electric power wiring infrastructure to simultaneously transport electrical power and high-speed data. This technology, known as “Power Line Carrier” (PLC) technology, typically uses broadband Orthogonal Frequency Division Modulated (OFDM) signals between 2 MHz and 30 MHz to facilitate communication on power wiring.

Power Line Carrier technology offers a number of significant practical advantage over other available LAN-based technologies. For example, a PLC-based LAN can be installed in a house or other building without installing a single in-wall wire. Further, PLC-based LANS can cover a greater area than can available wireless LANS. Unfortunately, existing PLC-based LANs have a limited data bandwidth of about 14 million bits-per-second and are subject to interference by every appliance and device drawing power from a LAN's power lines. Accordingly, new methods and systems capable of providing in-building LANs are desirable.

### SUMMARY OF THE INVENTION

In one aspect, a communication apparatus for implementing a broadband communication network using a cable-based television network installed in a building is disclosed, wherein the cable-based television network includes a video distribution device coupled to one or more coaxial cables, and wherein each coaxial cable can carry one or more downstream television broadcast signals and one or more upstream television control signals, the device includes a communications modem configured to transmit first communication signals over the one or more coaxial cables using a first allocated spectrum designed to avoid contention with ongoing upstream television control signals.

In a second aspect, a device for implementing a shared communication system over a cable-based television network installed in a building includes a broadband communication device coupled to the cable network and configured to transmit and receive first communication signals to/from the wired cable network via a coupling device, the first communication signals being allocated according to a spectral profile designed to avoid contention with upstream television control signals, wherein the first communication signals use a LAN protocol.

In a third aspect, a method for communicating over a demand cable television network, includes transmitting a broadband communication signal having embedded information onto the cable television network, the embedded information being derived from a signal provided by an Internet Service Provider (ISP), wherein the broadband communication signal is compliant with a local area network protocol, and where transmitting the broadband communication signal is designed to have no appreciable affect on cable television control signals residing on the cable network.

In a fourth aspect, a Local Area Network (LAN) includes a plurality of high-frequency broadband communication devices, wherein each communication device is coupled to a coaxial cable, and wherein the coaxial cable is capable of carrying separate and independent cable television control signals, wherein the broadband communication devices can communicate using a local area network protocol without interfering with the television control signals.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts the spectral profiles used by many broadband WAN and LAN technologies.

FIG. 2 depicts the spectral profiles used by HomePlug LAN and demand cable television technologies.

FIG. 3 depicts the spectral profiles used by HomePlug LAN and a modified demand cable television system.

FIG. 4A illustrates a frequency contention problem by a single wired network carrying both broadband LAN and demand cable television services.

FIG. 4B illustrates a first resolution for the frequency contention problem of FIG. 4A.

FIG. 4C illustrates a second resolution for the frequency contention problem of FIG. 4A.

FIG. 5A depicts a cable television infrastructure modified to carry both television and Internet/LAN services.

FIG. 5B depicts operable data paths available for a cable television network.

FIG. 6 is an exemplary gateway for the network of FIG. 5A.

FIG. 7 is an exemplary coupler for the network of FIG. 5A.

FIG. 8 depicts a high-level communication architecture of a LAN/cable television network.

FIG. 9 is a flowchart outlining an exemplary method for adapting a cable television network to carry broadband LAN signals.

FIG. 10 is a flowchart outlining an exemplary method for communicating using a LAN/cable television network.

FIG. 11 is a flowchart outlining a third exemplary method for communicating using a LAN/cable television network.

### DETAILED DESCRIPTION

Current technologies available to homeowners to create Local Area Networks (LANs) include various wireless technologies, such as Bluetooth and 802.11 networks, and Power Line Communication (PLC) networks, such as those provided by the HomePlug® standards. Unfortunately, both technologies have limited bandwidth, which can prove problematic in high-density housing and office settings.

However, many buildings (especially hotels and apartment) that have electrical wiring also have coaxial cable wires installed that might also be used to provide LAN services. While various broadband standards, such as Digital Subscribe's Line (DSL) have been adapted for use on coaxial cable, these technologies were developed for point-to-point communication/Wide Area Network (WAN) systems where design emphasis has been sending and receiving data over long distances in an upstream/downstream configuration. Additionally, these technologies are ill-suited for demand cable television systems due to frequency contention issues.

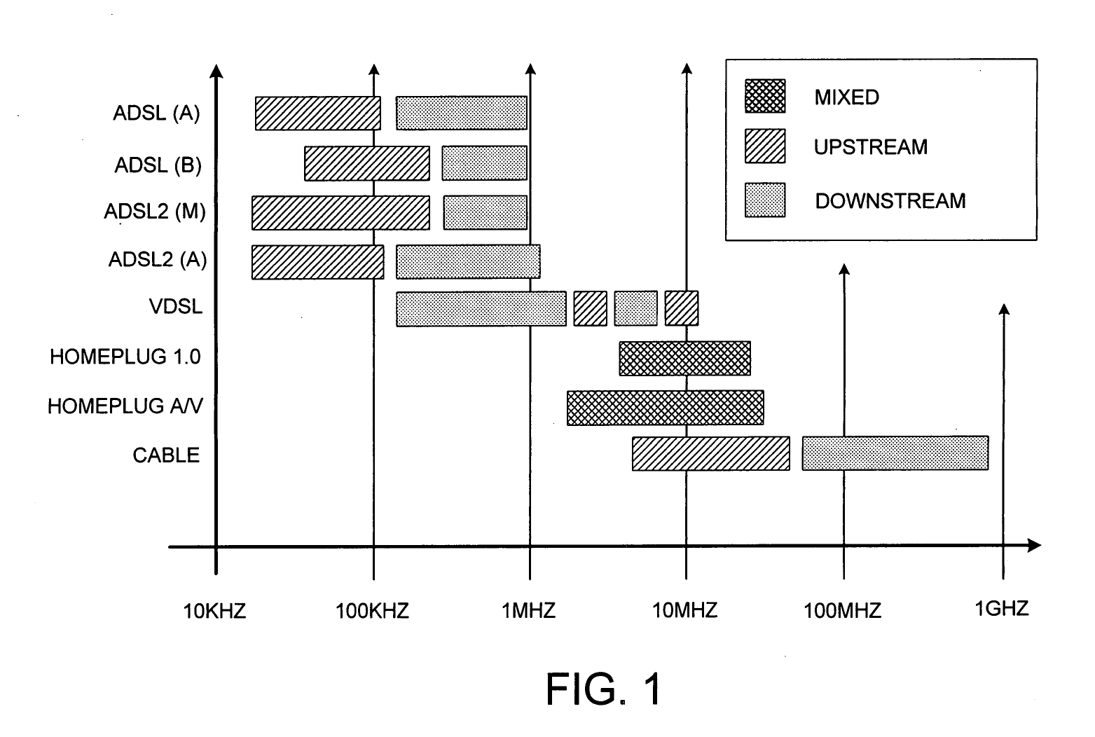

FIG. 1 depicts the bandwidths of various communications standards, including Symmetric High-bitrate DSL (SHDSL), various Asymmetric DSL (ADSL) standards and a Very high-speed DSL (VDSL) standard, the Homeplug 1.0 LAN standard and the Homeplug A/V LAN standard, as well as the bandwidth required by the majority of known demand cable television systems. As shown on FIG. 1, the exemplary cable television system has a downstream spectral profiles of about 60 MHZ to about 900 MHz, which is used for transmitting a variety of television signals, and an upstream portion of about 5 MHz to 50 MHz, which can be used by consumers to send command/request signals to a cable television provider in order to secure certain services, such as pay-per-view movies.

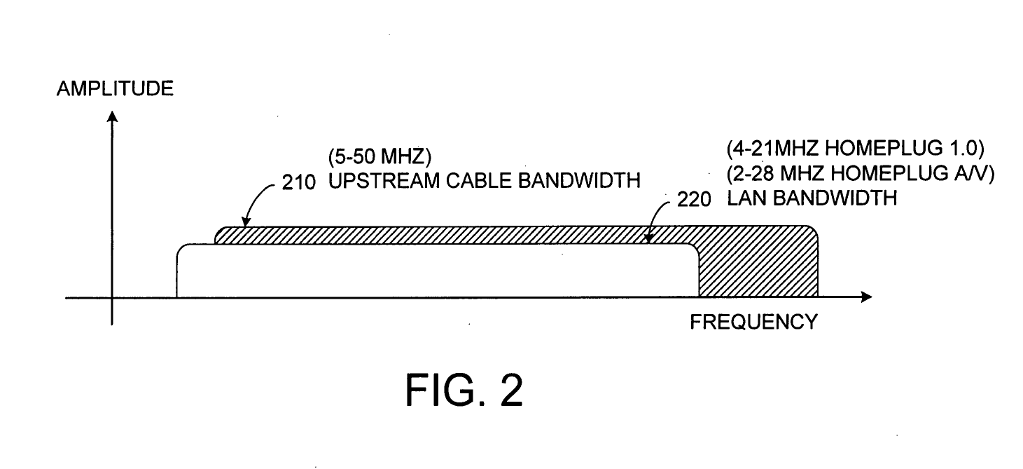

FIG. 2 illustrates the frequency overlap between the HomePlug standard signals 220 and the upstream cable television signals 210. As might be expected by the frequency contention depicted in FIG. 2, there may be severe interference between the two systems should they co-reside on a single cable. It should also be appreciated that other LAN standards, such as HomePNA 1.0/2.0, as well as certain WAN standards, e.g., VDSL, will have similar contention problems.

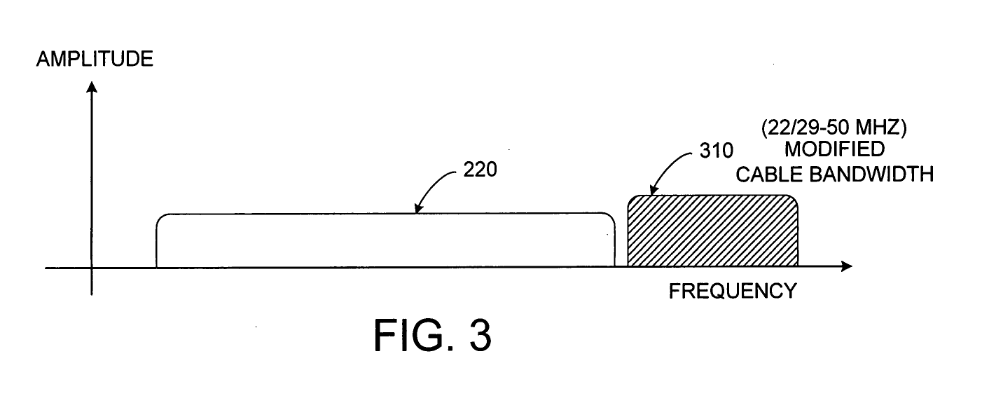

FIG. 3 depicts a first solution to resolving the contention problem illustrated in FIG. 2. The inventors of the disclosed methods and systems have discovered that, while demand cable television systems typically have 40 MHz-50 MHz upstream bandwidths, the actual bandwidths used or required are typically much smaller than that allotted. Accordingly, by modifying the reserved upstream cable bandwidth (see spectral profile 310), demand cable television might be easily made compatible with the Homeplug, HomePNA or similar broadband LAN systems available. While the solution of FIG. 3 is highly feasible, the downside is that it requires the cooperation of the demand cable television industry, which may not be incline to vary its standards for the benefit of other services.

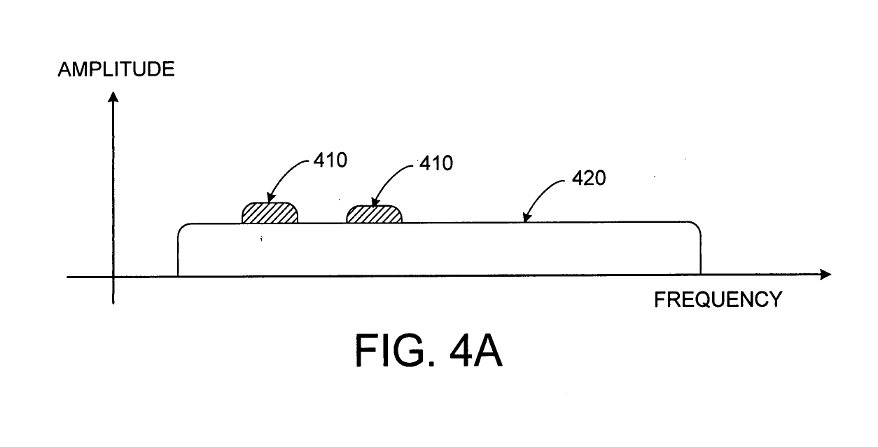

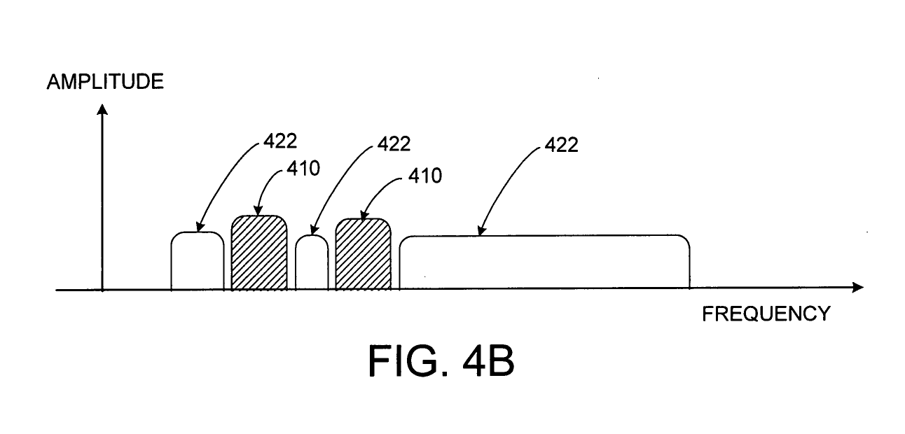

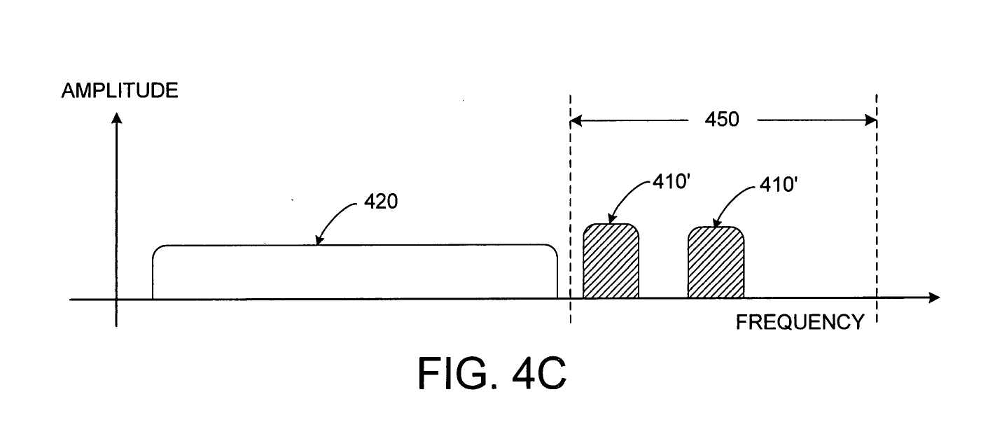

FIG. 4A depicts a first contention between a HomePlug spectral profile 420 and the spectral profile 410 of an exemplary demand cable television system. As shown in FIG. 4A, the Homeplug spectral profile 220 is partially superimposed with the upstream cable spectral profile 410. In view of the problems discussed above, the inventors of the disclosed methods and systems have devised a technique to artificially modify the communication spectra used by Homeplug modems to exclude the use of selected frequencies among the large number of frequencies earmarked by the HomePlug standards. For example, a review of FIG. 4B illustrates that, using the inventors' approach, a modified HOMEPLUG spectral profile 422 can be devised to avoid contention with the cable television spectral profile 410. As shown in FIG. 4B, the modified homeplug spectral profile 422 is broken into three sub-section in order to avoid overlap with the cable spectral profile 410.

FIG. 4C depicts an alternative solution to that of FIG. 4B. That is, instead of modifying the Homeplug spectral profile 420, upstream communication signals can be reassigned (in whole or in part) to a non-overlapping portion 450 of the available demand cable specifications. Considering that the spectral range for cable television upstream signals is typically from 5 MHz to 50 MHz, and the spectral range for Homeplug signals is typically from 2/4 MHz to 21/28 MHz), the available non-overlapping portion can be expected to be from about 21/28 MHz to about 50 MHz. The advantage of the approach of FIG. 4C is that the full available spectra of the LAN can be used, thus increasing data throughput, without hindering upstream cable television signals. The downside of course is that such an approach may require the cooperation of a cable television provider.

While the approaches depicted in FIGS. 4A and 4B were illustrated with Homeplug in mind, it should also be appreciated that other LAN standards, such as HomePNA 1.0/2.0, as well as certain WAN standards, e.g., VDSL, that have similar contention problems might similarly be resolved. However, regardless of the LAN or WAN system used, the following characteristics can be desirable for a cable-based communication system, especially when a consumer wishes to employ a LAN on his cable television network:

(A) Point-to-multipoint capability, which refers to the capability where a first device can simultaneously communicate with multiple other devices on a LAN. Compare direct point-to-multipoint capability, which refers to the capability where a first device can simultaneously communicate with multiple other devices on a LAN without intervention of an intermediate device, such as a network hub. Also compare Specific-frequency point-to-multipoint capability, which refers to the capability where a first device can simultaneously communicate with multiple other devices on a LAN using a particular carrier frequency. Contrast this capability with the various DSL standards, which generally allow only point-to-point communication. While there are some DSL standards that are partially point-to-multipoint from the standpoint that an upstream device can simultaneously communicate with multiple downstream devices, such communication is limited in that the upstream device maintains communication with each downstream device using separate carrier frequencies in a Discrete Multi-Tone (DMT) environment.

(B) Digital encryption, such as the Digital Encryption Standard (DES) or triple Digital Encryption Standard (3DES or DES3). Presently, DSL and other known WAN standards do not use or need such capability.

(C) An Orthogonal Frequency Division Multiplexing (OFDM) format, which helps to increase data bandwidth while decreasing the effects of multi-path signal distortion. While various DSL protocols use a signal format having similarities to OFDM known as DMT, OFDM has a number of advantages over DMT, such as the need for but a single modem.

(D) A contention protocol, such as Carrier Sense Multiple Access/Collision Detection (CSMA/CD), Carrier Sense Multiple Access/Collision Avoidance (CSMA/CA) and Token Passing. The CSMA/CD is a popular protocol that is both fast and commonly used. Examples of networks using CSMA/CD include Ethernet and 100baseT networks.

While the CSMA/CA protocol is not as fast as the CSMA/CD protocol, CSMA/CA has an advantage in that it provides for the “hidden node” problem. The hidden node problem occurs in a point-to-multipoint network having at least three nodes, e.g., Node A, Node B and Node C. It may be possible that in certain cases Node B can hear Node A (and vice versa) and Node B can hear Node C (and vice versa) but Node C cannot hear Node A. That is, Nodes A and C are effectively hidden from one another. In such an environment both Node A and Node C could both properly transmit a packet simultaneously in a CSMA/CD environment since they cannot hear each other on a ‘listen’ phase, but the result is that Node B would get corrupted data. However, unlike a CSMA/CD protocol, a CSMA/CA protocol could prevent Nodes A and C from simultaneously transmitting (with resulting data corruption).

(E) Full spectral bi-directionality, which for the purpose of this disclosure means that almost any device coupled to a network can both receive and transmit information using all or substantially all of an available communication bandwidth. For example, the POTS, ISDN and SHDSL technologies shown in FIG. 1 have full spectral bi-directionality in that their entire useable bandwidths can be used for both transmission and reception. In contrast, the ADSL and VDSL standards allocate separate spectra for separate upstream and downstream data transmission.

(F) Error Detection and/or Error Correction, which may include Cyclic Redundancy Coding CRC), Forward Error Correction (FEC), Block coding (such as BCH) or any other existing or later developed error detection or correction technology.

(G) Packet Transmission, which infers that data is transmitted in discrete packets.

(G) Burst Transmission, which infers that data is transmitted in discrete bursts, i.e., the carrier signal is silent when there is no communication.

(H) Hub-and-Spoke Topology, which refers to a widely-known communication topology where a central hub is used to receive and retransmit data.

(H) Hub-Versatile Topology, which refers to a topology where various terminals may optionally use a hub to communicate or may opt to communicate directly with one another.

(H) Daisy-chain Topology, which refers to a widely known topology where data is passed from one terminal to another, then to another until the intended destination terminal receives the transmitted data.

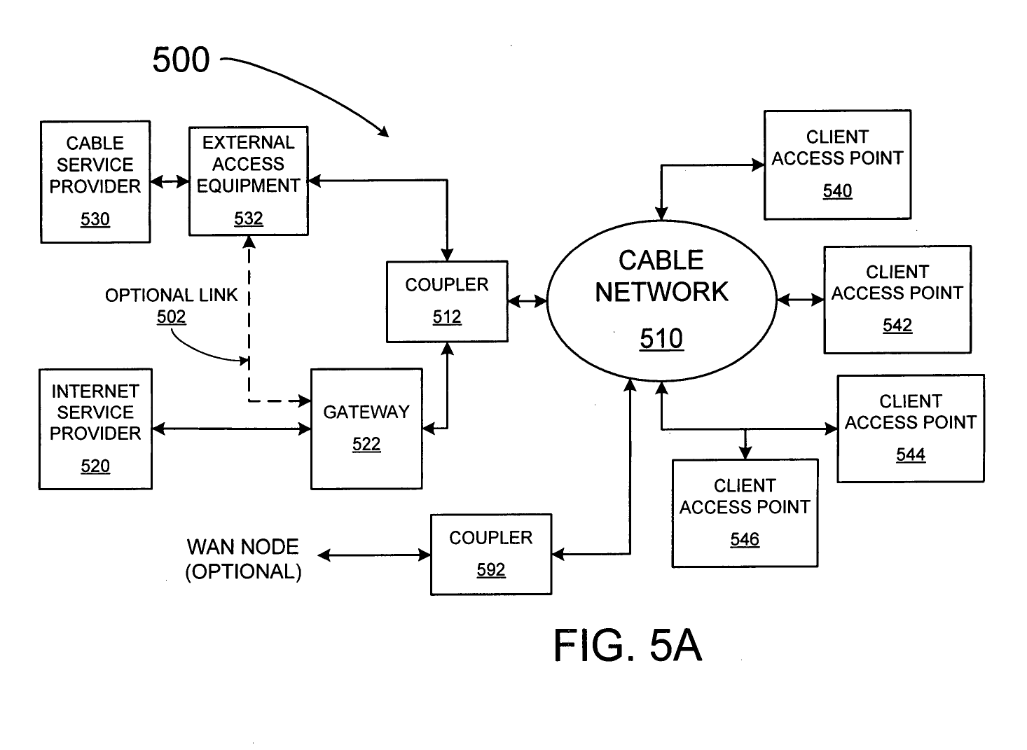

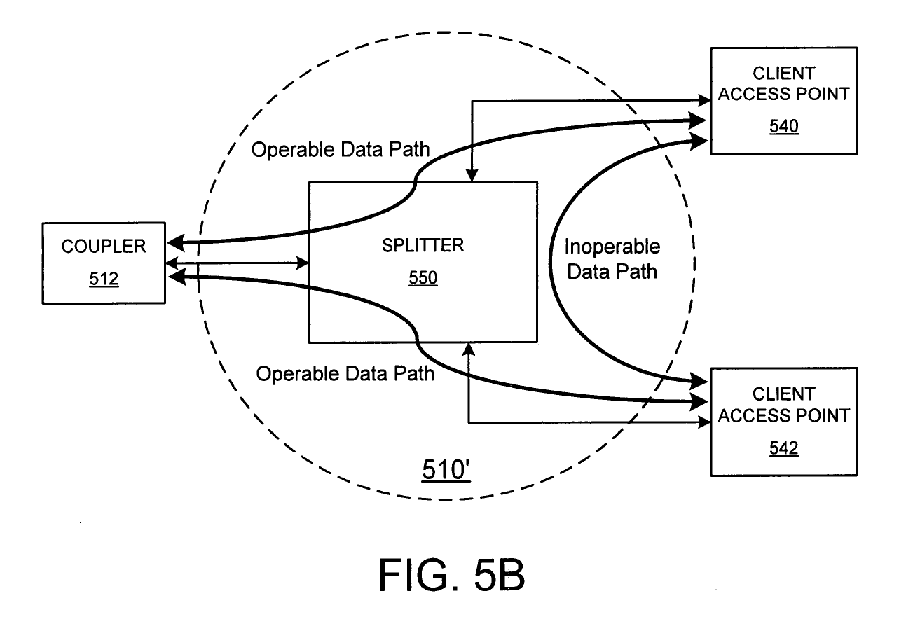

FIG. 5A depicts an exemplary communication system 500 wherein a LAN is imposed on a cable television network. As shown in FIG. 5A, the communication system 500 includes a cable network 510 coupled to a cable service provider 530 via some external access equipment 532 and a coupler 512. The cable network 510 is also coupled to an internet service provider (ISP) 520 via a LAN gateway 522 and CableTV-LAN coupler 512. Still further, the cable network 510 is coupled to a number of client access points 540-546 and an optional external WAN node (not pictured) via a WAN coupler 592.

In operation, the cable network 510 can be used to transport television signals from the cable service provider 530 to consumers (located at the client access points 540-546). When a client access point 540-546 is in communication with the cable service provider 530, the television signals would, of course, be relayed/transmitted/received via the external access equipment 532 and coupler 512

Simultaneously, the cable network 510 can be used to transport various broadband signals, such as HomePlug compatible (or other LAN signals) both between client access points 540-546 and to/from individual client access points 540-546 and an external device or system, e.g., a specific communication node on the ISP 520. When a client access point 540-546 is in communication with the ISP 520, the broadband signals would, of course, be relayed/transmitted/received via the LAN gateway 522 and coupler 512.

As discussed above, in addition to the television and LAN signals, the cable network 510 might also be used to convey WAN signals to and from an external WAN node via the WAN coupler 592. Additionally, Integrated Services Digital Network (ISDN) or Symmetric High-speed DSL (SHDSL) communication signals might be simultaneously transmitted over the cable network without interference of both television and Homeplug (or HomePNA) signals.

Also as discussed above, in various embodiments, it may be desirable to reconfigure the spectral profile of upstream cable television signals rather than reconfigure the spectral profile of the LAN signals. In either case, such reconfiguring might be accommodated using optional link 502 between the gateway 522 and the television external access equipment 532. For example, before the gateway 522 goes online, the gateway 522 and the television external access equipment 532 can share spectral information and allow for one or the other to reconfigure.

The exemplary cable network 510 consists of one or more pairs of coaxial cables commonly used for cable television purposes and interconnected using various connectors and splitters/combiners also commonly used for cable television. However, it should be appreciated that the particular physical makeup of the cable network 510 can take any combination of electrical forms as long as such form is amicable to high-frequency signals

The external access equipment 532 of the present example of FIG. 5A is a computer-controlled device capable of passing television signals downstream to consumers, receiving upstream commands from consumers and providing various services, e.g., pay-per-view movies, based on the received upstream commands. However, the external access equipment 532 can also take any other known or later developed form of television equipment (televisions, VCRs, DVD recorders etc) capable of linking television equipment with a television service provider without departing from the spirit and scope of the present disclosure.

The gateway 522 of the present example of FIG. 5A can be any of a number of HomePlug-based gateways capable of interconnecting computer-based devices on a cable network and possibly interconnecting these devices with an ISP or other external data node. However, in variants not using HomePlug technology, the gateway 522 is envisioned to take any suitable form capable of communicating with various computer-based devices over a cable network using a LAN protocol without departing from the spirit and scope of the present disclosure.

FIG. 5B depicts a particular limitation on using television cable networks for LAN services. As shown in FIG. 5B, a network portion 510′ of the network 510 of FIG. 5A is shown with a video splitter 550, one of many that might be expected to be found. The video splitter 550 is connected to a coupler 512 upstream, and further connected to a number of client access points 540-542 downstream. Due to the nature of video splitters, the operable data paths are generally limited for most signals to upstream-to-downstream and downstream-to-upstream. Accordingly, while the video splitter 550 can provide useable data paths between the coupler 512 and each of the client access points 540-542, the individual client access points 540 and 542 can be effectively isolated from one another for most frequencies of interest.

While some network developers have attempted (with limited success) to bypass this limitation by relying on a small amount of “leakage” inherent in splitters or using sufficiently low frequencies where splitters behave differently, these approaches are generally unsuitable for high-speed communication. Accordingly, the inventors of the disclosed methods and systems have employed an upstream gateway that would be in the operable data path for various client access points as a repeater. For example, while client access point 540 could not directly communicate with client access point 542, messages between the two client access points 540 and 542 could easily be relayed to one another via a gateway (or other device) upstream relative to both client access points 540 and 542.

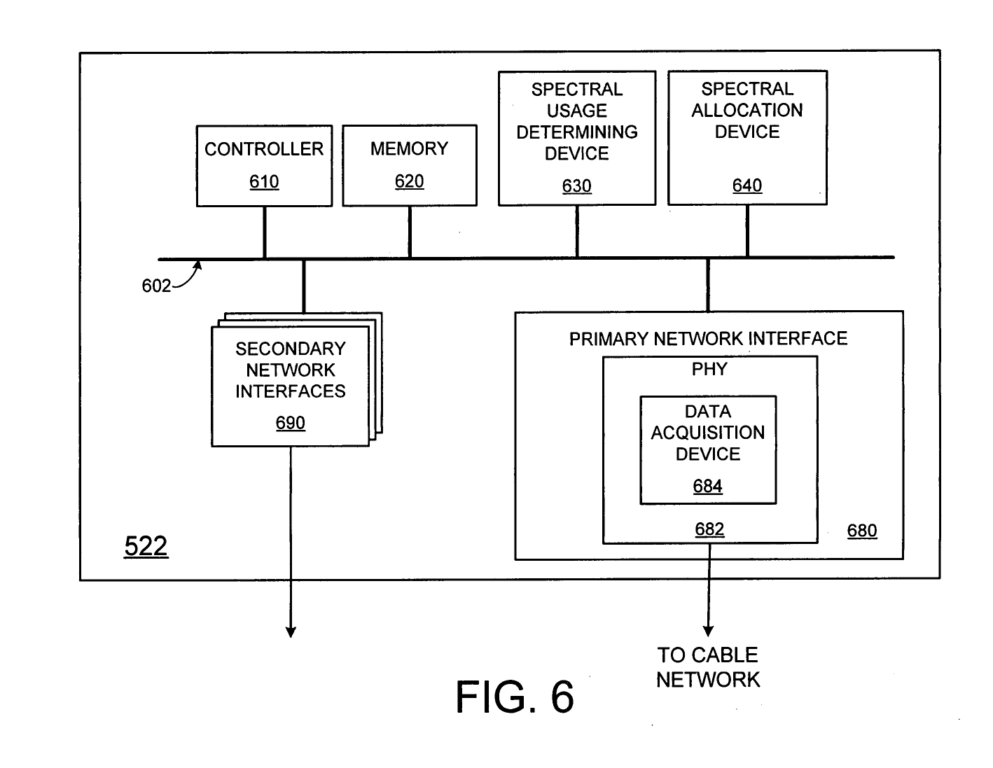

FIG. 6 depicts an exemplary gateway 522. As shown in FIG. 6, the gateway 522 includes a controller 610, a memory 620, a spectral usage determining device 630, a spectral allocation device, a primary network interface 680 and a number of secondary network interfaces 680. The primary network interface 680 includes a physical device (PHY) 682, which itself includes a data acquisition device 684. The above components 610-990 are coupled together by control/data bus 202.

Although the exemplary gateway 522 uses a bussed architecture, it should be appreciated that any other architecture may be used as is well known to those of ordinary skill in the art. For example, in various embodiments, the various components 610-690 can take the form of separate electronic components coupled together via a series of separate busses.

Still further, in other embodiments, one or more of the various components 610-690 can take form of separate servers coupled together via one or more networks. Additionally, it should be appreciated that each of components 610-690 advantageously can be realized using multiple computing devices employed in a cooperative fashion.

It also should be appreciated that some of the above-listed components can take the form of software/firmware routines residing in memory 620 and be capable of being executed by the controller 610, or even software/firmware routines residing in separate memories in separate servers/computers being executed by different controllers. Further, it should be understood that the functions of any or all of components 630-640 can be accomplished using object-oriented software, thus increasing portability, software stability and a host of other advantages not available with non-object-oriented software.

Further, while the exemplary secondary network interfaces 690 are a combination of devices and software/firmware configured to couple computer-based systems to the Internet over an electrically wired line using an ethernet protocol, it should be appreciated that, in differing embodiments, the secondary network interfaces 690 can take the forms of modems, networks interface card, serial buses, parallel busses, WAN or LAN interfaces, wireless or optical interfaces, any number of distributed processing networks or systems, a virtual private network device, Token Ring, a Fiber Distributed Datalink Interface (FDDI), an Asynchronous Transfer Mode (ATM) based system, a telephony-based system including Ti and El devices, a, a wireless system and the like as may be desired or otherwise dictated by design choice.

In operation, an operator can first couple one or more of the secondary interfaces to a number of external devices, such as an ISP connection and perhaps equipment related to a cable television provider. The operator can then couple the primary network interface 680 to a coaxial cable or other physical medium carrying television signals.

Next, the operator can program the gateway 522 to transmit and receive according to a specific spectral profile in order to avoid signal contention between the gateway 522 and any resident television-related signals.

In a first mode of operation, the gateway 522 can receive such spectral information/instructions via an external source via an operator. This mode assumes that the operator can either determine the used and available frequency spectra via testing or using some other technique, such as by inspecting the relevant television equipment, reviewing the appropriate equipment logs, requesting the information from a cable television provider, etc.

In a second mode of operation, the gateway 522 can receive such information directly from the relevant television equipment via one of the secondary network interfaces 690. Alternatively, such information may be taken from a computer-based device containing a database of such information.

In a third mode of operation, the gateway 522 can receive such information by performing certain tests directly on the television cable (or other physical medium) via the primary network interface 680. In this mode, operation starts by using the data acquisition device 684 of the PHY 682 to record significant activity at certain frequencies of interest. For example, if the gateway 522 were using 256 frequencies equally spaced between 5 MHz and 25 MHz to communicate, the data acquisition device 684 (which can be any combination of filtering, frequency shifting, digitizing and other electronic devices) could digitally sample about each frequency of interest and store the data in memory 620.

Next, spectral usage determining device 630 can analyze the stored data using any number of available techniques, e.g., Fourier transforms, to determine whether each frequency of interest is being used by other (non-LAN) equipment. Once these determinations are made, the spectral usage information (whether internally determined or provided by an external source) is sent to the spectral allocation device 640, which can then allocate the spectral profile available to the gateway 522 also taking into account the need for guard-band between television signals and gateway signals as well as other considerations of interest. The allocate the spectral profile information is then programmed into the primary network device 680, which in turn can then be activated so that it can communicate with other LAN-based devices without interfering with television-related signals.

Again as discussed above, in an alternative mode of operation, instead of programming primary network device 680, the exemplary gateway 522 can communicate with various pieces of television equipment in order to request that such equipment reassign its used spectra above that used by the gateway 522, but within the specified range, e.g., between 21 MHz and 50 MHz for Homeplug 1.0. In situations where some, but not all, of such used spectra can be reassigned, the gateway 522 can still benefit by using a combination of cable television reassignment and LAN spectral allocation techniques to substantially maximize the available communication bandwidth.

Once the spectral profile for the gateway 522 is established, such information may be made available to other devices via the available cable network using a special protocol, or such information may be programmed into the other devices before installation, manually after installation and so on.

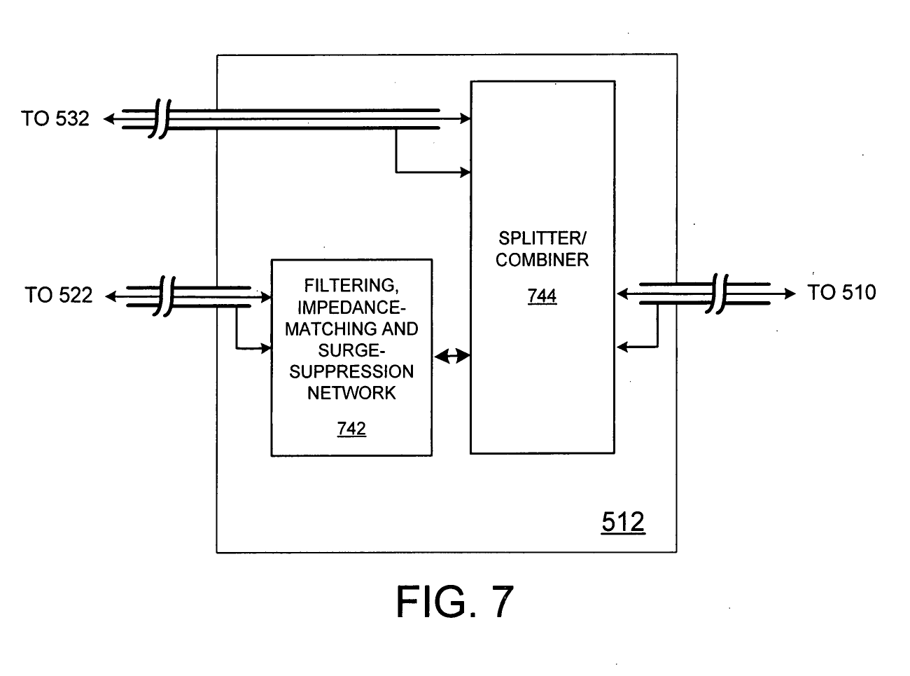

FIG. 7 depicts an exemplary coupler 512 capable of linking both a baseband television device and a broadband communication device to a common cable network, such as the television network 510 depicted in FIG. 5A. As shown in FIG. 7, the coupler 512 includes a filtering, impedance matching and surge suppression network 742 and a splitter/combiner 744. The network 542 is used to appropriately match the characteristics of a gateway to a television network and to prevent high-voltage spikes that may appear on a particular television network from damaging a gateway (or other equipment), prevent human injury and to generally to conform to any applicable regulations or mandates of television networks. The splitter/combiner 744 is used to couple the various television and communication signals on a single medium. While the exemplary coupler 512 is used in combination with a gateway, it should be appreciated that similar devices can be used at the various client access points 540-546 of FIG. 5A according to the present disclosure.

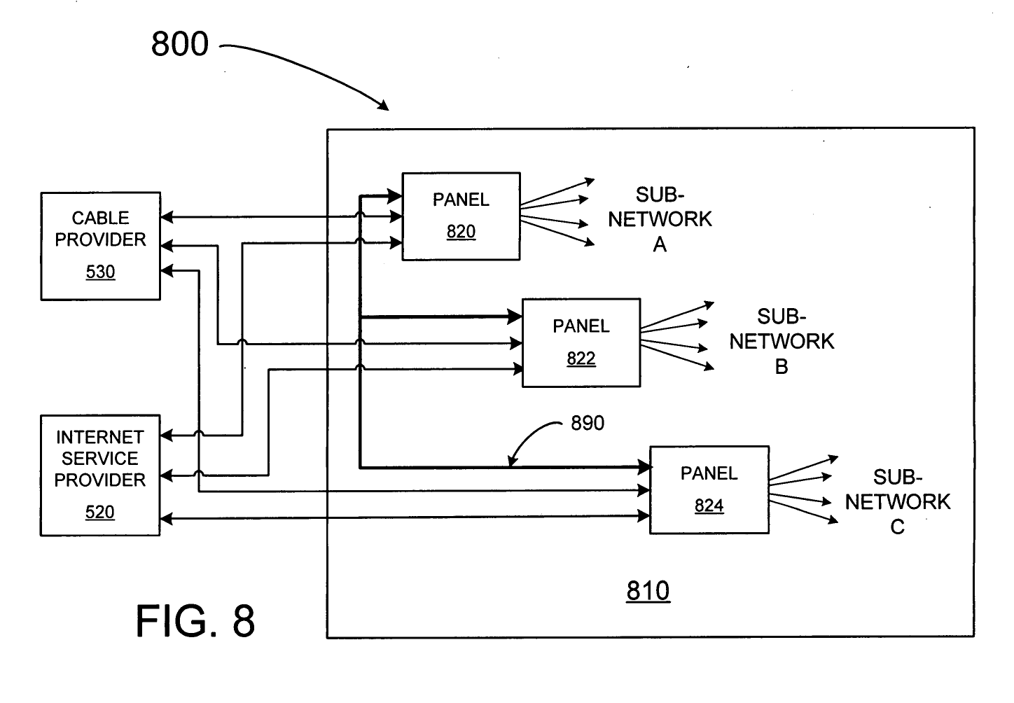

FIG. 8 depicts a high-level communication architecture of a CableTV-LAN television network located in a single building 810 having a number of independent and electrically isolated television sub-networks A, B and C, which can be accessible by respective panels (equipment centers) 820, 822 and 824 also located within the building 910. The exemplary panels 820, 822 and 824 of the exemplary embodiment can be accessed by a common cable provider 530 and common ISP 520, but in other embodiments panels 820, 822 and 824 can be accessed by different television and ISPs. It should be appreciated that electrical isolation of the sub-networks A, B and C can provide a boon as individual gateways (potentially located at each panel 820, 822 and 824) can have a lower number of clients to serve, thus increasing the available bandwidth per client.

However, in certain circumstances where a substantial connectivity between two sub-networks is required, the isolation depicted in FIG. 8 can pose a disadvantage when a client on one sub-network needs to quickly communicate with another client on another sub-network. Accordingly, a common network line 890 can be installed between the panels 820, 822 and 824 to alleviate such isolation. The common network line 890 of the exemplary embodiment is an Ethernet-based line using dedicated wiring and is connected to gateways (not shown but residing in the panels 820, 822 and 824) capable of converting signals between CableTV-LAN and ethernet protocols. However, it should be appreciated that in various embodiments the form of the common network line 890 can vary to employ any number of known technologies and forms, such as a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a television-based system including T1 and E1 devices, a wired system, an optical system, a wireless system and so on.

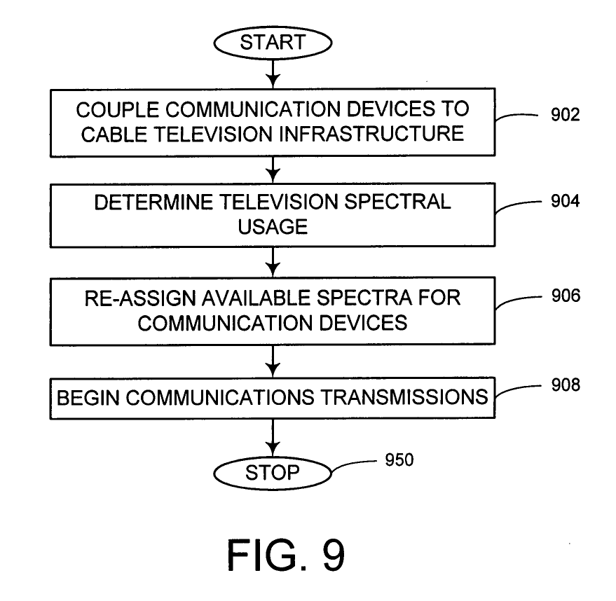

FIG. 9 is a flowchart outlining a first exemplary method for adapting a cable television network to carry LAN broadband communication signals. The process starts in step 902 where various LAN components of interest, such as a gateway, are coupled onto a cable television infrastructure. Next, in step 904, the television spectral usage of the cable television infrastructure is determined according to any known or later developed suitable technique. Control continues to step 906.

In step 906, the spectral profile for the communication device and/or the relevant television equipment is reassigned/reallocated to avoid contention issues. Next, in step 908, communication between the gateway and various client access points can commence. Control then continues to step 950 where the process stops.

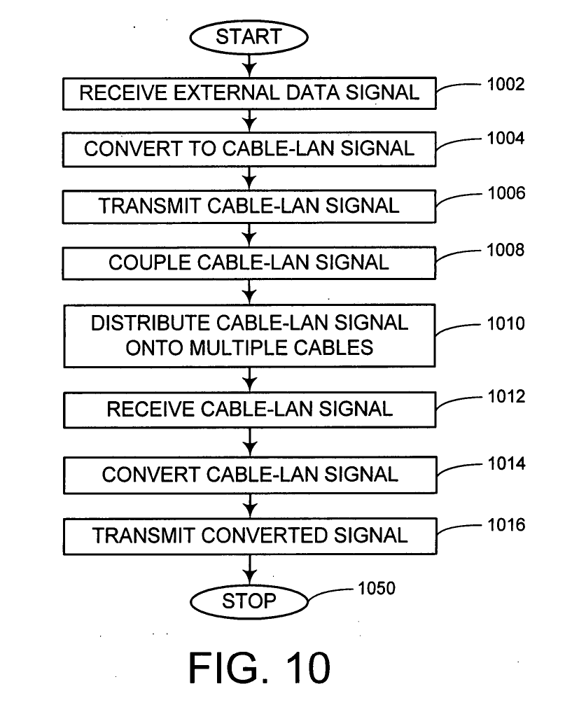

FIG. 10 is a flowchart outlining a second exemplary method for communicating using a CableTV-LAN network. The method starts in step 1002 where one or more data signals are received from an external device (such as a computer-based device) by a gateway or bridge (or other suitable device). Next, in step 1004, the data signals are effectively converted to a high-frequency broadband LAN signal, such as any of the various LAN signals discussed above. Then, in step 1006, the LAN signals are transmitted over a first coaxial cable of the cable-based television network. Control continues to step 1008.

In step 1008, the transmitted LAN signals are then coupled from the first coaxial cable onto a second coaxial cable of the cable-based television network. As discussed above such coupling can be made possible via an appropriate coupling device or combiner/splitter. Next, in step 1010, the transmitted LAN signals can be further distributed onto multiple coaxial cables. Control continues to step 1012.

In step 1012, the LAN signal can be received by each intended recipient on the second coaxial cable. Next, in step 1014, the received LAN signals can be appropriately converted. Then, in step 1016, the converted signals are transmitted to a targeted receiving device. Control then continues to step 1050 where the process stops.

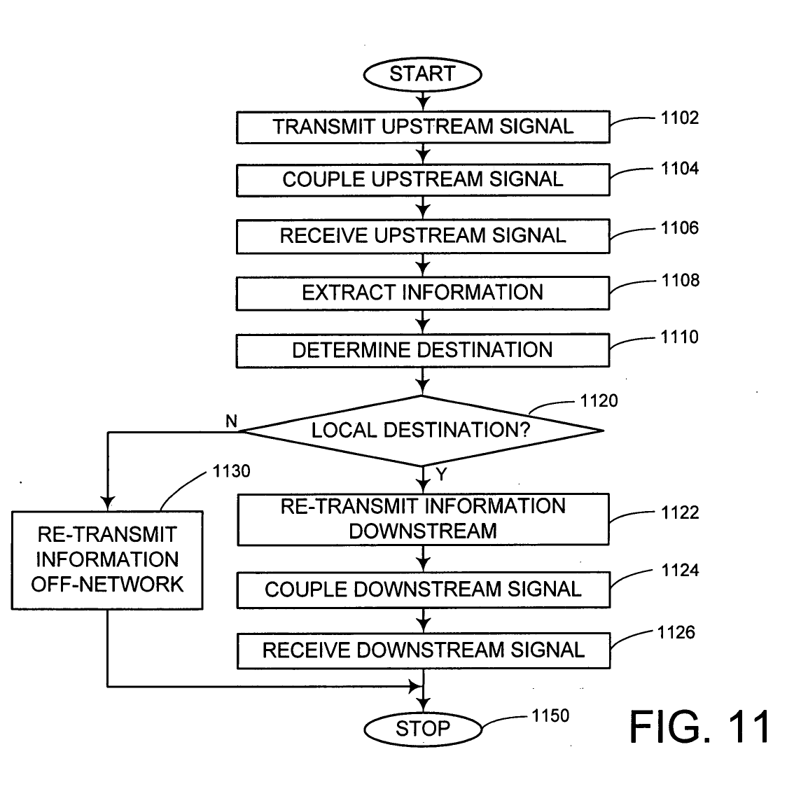

FIG. 11 is a flowchart outlining a third exemplary method for communicating using a CableTV-LAN network that takes into account the data path issues discussed above with references to FIG. 5B. The method starts in step 1102 where a LAN-based device coupled to a cable television network consisting primarily of coaxial video cable and video splitters transmits a LAN signal upstream. Next, in step 1104, the upstream LAN signal is transported upstream through the cables and coupled through the couplers. Then, in step 1106, the upstream LAN signal is received by a specialized LAN gateway or other device. Control continues to step 1108.

In step 1108, information contained in the received signal is extracted. Next, in step 1110, the ultimate/desired destination of the LAN signal is determined based on a portion of the extracted information. Then, in step 1120, a determination is made as to whether the desired destination is local, i.e., coupled to the cable television network. If the desired destination is local, control continues to step 1122: other wise, control jumps to step 1130.

In step 1122, the information extracted in step 1110 is repackaged and transmitted in a downstream LAN signal. Next, in step 1144, the downstream LAN signal is transported downstream through the appropriate cables and coupled through the appropriate couplers. Then, in step 1126, the downstream LAN signal is received by the intended device. Control continues to step 1150 where the process stops.

In step 1130, the information extracted in step 1110 is repackaged and transmitted off-network to an ISP or another network. Control continues to step 1150 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to communication services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A communication apparatus for implementing a broadband communication network using a cable-based television network installed in a building, wherein the cable-based television network includes a video distribution device coupled to one or more coaxial cables, and wherein each coaxial cable can carry one or more downstream television broadcast signals and one or more upstream television control signals, the device comprising:
a communications modem configured to transmit first communication signals over the one or more coaxial cables using a first allocated spectrum designed to avoid contention with ongoing upstream television control signals.

2. The device of claim 1, further comprising a spectral allocation device that allocates the first spectrum for the first communication signals based on the upstream spectrum of the one or more upstream broadcast control signals in a manner to avoid frequency conflicts between the one or more upstream broadcast control signals and first communication signals transmitted or received by the communication apparatus.

3. The device of claim 1, further comprising a means for determining the upstream spectrum of the one or more upstream broadcast control signals.

4. The device of claim 3, wherein the means for determining the upstream spectrum includes a receiving device capable of receiving spectral information from an external device.

5. The device of claim 3, wherein the means for determining the upstream spectrum includes a data acquisition device capable of sensing electrical signals on a television cable.

6. The device of claim 5, wherein the means for determining the upstream spectrum further includes a spectral usage determining device configured to detect electrical signals at one or more frequency ranges.

7. The device of claim 1, wherein the first communication signals use an Orthogonal Frequency Division Multiplexed (OFDM) format.

8. The device of claim 1, wherein the first communication signals use a collision avoidance protocol.

9. The device of claim 1, wherein the communication apparatus is configured to communicate over the cable-based television network using a substantially full spectral bi-directionality protocol.

10. The device of claim 6, wherein the first communication signals comply with a Homeplug standard.

11. The device of claim 10, wherein the first communication signals are power-adjusted in such a way as to not distress television components on the cable network.

12. The device of claim 1, wherein the communication apparatus provides a communication interlink between an external Internet Service Provider (ISP) and at least one computer-based device coupled to the cable-based television network.

13. The device of claim 12, further comprising one or more client access points electrically coupled to the cable network, each access point having a computer-based device capable of communicating with the gateway via the cable network.

14. The device of claim 13, wherein each client access point includes a bridge capable of translating between the LAN protocol of the wired telephony network and a respective computer-based device.

15. A device for implementing a shared communication system over a cable-based television network installed in a building, the device comprising:
a broadband communication device coupled to the cable network and configured to transmit and receive first communication signals to/from the wired cable network via a coupling device, the first communication signals being allocated according to a spectral profile designed to avoid contention with upstream television control signals;
wherein the first communication signals use a LAN protocol.

18. A method for communicating over a demand cable television network, comprising:
transmitting a broadband communication signal having embedded information onto the cable television network, the embedded information being derived from a signal provided by an Internet Service Provider (ISP);
wherein the broadband communication signal is compliant with a local area network protocol, and where transmitting the broadband communication signal is designed to have no appreciable affect on cable television control signals residing on the cable network.

19. The method of claim 18, wherein the broadband communication signal is substantially compliant with a Homeplug communication standard.

20. The method of claim 19, further comprising receiving the broadband communication signal via the cable network, then extracting the embedded information from the broadband communication signal.

21. A Local Area Network (LAN), comprising:
a plurality of high-frequency broadband communication devices, wherein each communication device is coupled to a coaxial cable, and wherein the coaxial cable is capable of carrying separate and independent cable television control signals; and
wherein the broadband communication devices can communicate using a local area network protocol without interfering with the television control signals.

22. A system for adapting a cable television network that carries both video and video control signals to provide a local area network, wherein the cable television network includes a video access device for providing video services to a plurality of client access points, and wherein the video access device is coupled to the client access points by plurality of coaxial cables and one or more video splitters, the system comprising:
a local area network gateway configured to receive upstream signals transmitted from a first client access point, wherein the local area network gateway is coupled to the first client access point via at least one cable and one video splitter; and
wherein the local area network gateway is further configured to retransmit information received in the upstream signals downstream to a second client access point, wherein the local area network gateway is coupled to the second client access point via at least one cable and one video splitter.

23. The system of claim 22, wherein either the first cable or the first video splitter is not in the path between the local area network gateway and the second client access point

24. The system of claim 22, further comprising a plurality of computer-based devices located at the client access points, wherein the computer-based devices are configured to send and receive information to other client access points via local area network gateway.

25. The system of claim 22, further comprising a local area network coupler couple coupled to the local area network gateway and a first coaxial cable of the cable television network.

26. The system of claim 25 wherein the local area network coupler couple includes an impedance-matching circuit that substantially optimizes the transmission and reception of signals to and from the local area network gateway and the first coaxial cable of the cable television network.

27. The system of claim 26, wherein the local area network gateway communicates with the client access points via an orthogonal frequency dependant multiplexed protocol.

28. A method for communicating over a cable television network that carries both video and video control signals, wherein the cable television network includes a video access device for providing video services to a plurality of client access points in the cable television network, and wherein the video access device is coupled to the client access points by plurality of coaxial cables and one or more video splitters, the method comprising:
receiving an upstream signal transmitted from a first client access point via at least a first cable and a first video splitter; and
transmitting information receive in the upstream signal downstream to a second client access point via at least a second cable and a second video splitter;
wherein either the first cable or the first video splitter is not in the path to the second client access point

29. The method of claim 28, further the steps of:
extracting information from the received upstream signal; and
determining an intended destination of the information from the extracted information.

30. The method of claim 29, wherein the step of transmitting information downstream to the second client access point is conditioned on whether the intended destination is part of the cable television network.

31. The method of claim 29, further comprising providing internet access to the first and second client access point via the cable television network.

32. The method of claim 29, further comprising providing internet access to a second local area network to the first and second client access point via the cable television network.

33. The method of claim 29 further comprising providing internet access to the first and second client access point via the cable television network.

34. The system of claim 28 wherein the upstream and downstream signals have an orthogonal frequency dependant multiplexed protocol.
